(19) United States
(12) Patent Application Publication
(10) Pub. No.: US 2009/0251676 A1
(43) Pub. Date: Oct. 8, 2009

(54) Exposure apparatus and exposure method

(76) Inventors: Kazuki Komori, Kanagawa-ken (JP); Hiromi Ishikawa, Kanagawa-ken (JP); Toshihiko Omori, Kanagawa-ken (JP); Yoji Okazaki, Kanagawa-ken (JP); Tomoyuki Baba, Saitama-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/921,406

(22) PCT Filed: May 30, 2006
(86) PCT No.: PCT/JP2006/310762

§ 371 Date: Feb. 23, 2009

(30) Foreign Application Priority Data
Jun. 3, 2005 (JP) 2005-164202

(51) Int. Cl. G03B 27/72

(52) U.S. Cl. 355/71

(57) ABSTRACT

An exposure image is accurately projected. An exposure apparatus includes a light source for emitting exposure light, a DMD, which includes a plurality of two-dimensionally-arranged pixel portions, and a telecentric optical system for collimating principal rays of the exposure light. The telecentric optical system is positioned in an optical path of the exposure light that enters the DMD. The DMD performs, based on an image signal, spatial light modulation on exposure light, which has been emitted from the light source, and that has entered the plurality of pixel portions, for each of the plurality of pixel portions.

### TECHNICAL FIELD

The present invention relates to an exposure apparatus and an exposure method for performing exposure on a photosensitive material by illuminating the photosensitive material with exposure light on which spatial light modulation has been performed by a spatial light modulator.

### BACKGROUND ART

Conventionally, an exposure apparatus including a spatial light modulation means that forms a two-dimensional pattern by performing, based on an image signal, spatial light modulation on incident light has been known. In the exposure apparatus, exposure is performed by projecting the formed two-dimensional pattern onto a photosensitive material. As the spatial light modulation means, a digital micromirror device (hereinafter, represented by “DMD”) is well known (please refer to Japanese Unexamined Patent Publication No. 2001-305663, for example). In the DMD, a multiplicity of micromirrors, the inclination angles of which can be changed, are two-dimensionally arranged. As the DMD, a device developed by Texas Instruments Incorporated is well known, for example.

An exposure apparatus including a DMD, as described above, includes a plurality of exposure heads, each including a light source, an illumination optical system, a DMD and an imaging optical system. The light source emits exposure light. The illumination optical system illuminates the DMD with the exposure light. The DMD is positioned substantially at a focal position of the illumination optical system. The imaging optical system forms an image of a two-dimensional pattern of light reflected by the DMD. The two-dimensional pattern of light is output from the exposure heads and projected onto a photosensitive material on a stage that moves in a scan direction. Accordingly, the photosensitive material is exposed to light.

In the exposure apparatus including the exposure heads, as described above, the DMD forms a two-dimensional pattern by performing spatial light modulation on exposure light that has illuminated the DMD. In other words, each pixel of the two-dimensional pattern is formed by exposure light that has been reflected by each of the micromirrors forming the DMD. Therefore, it is important that each of the micromirrors accurately reflects the exposure light to form the two-dimensional pattern. However, in actual cases, since the angles of principal rays (chief rays) of exposure light that enters the micromirrors are not uniform, the angles of principal rays of exposure light reflected by the micromirrors are not uniform, either. Consequently, the pitch of pixels forming the two-dimensional pattern tends to become irregular. If the pitch of pixels forming the two-dimensional pattern projected onto the photosensitive material is irregular, the quality of an image formed by exposure becomes lower and the quality of exposure becomes lower.

In view of the foregoing circumstances, it is an object of the present invention to provide an exposure apparatus and an exposure method for accurately projecting an exposure image.

### DISCLOSURE OF INVENTION

To solve the aforementioned problems, an exposure apparatus of the present invention is characterized by comprising;

a light source for emitting exposure light;

a spatial light modulation means that includes a plurality of two-dimensionally-arranged pixel portions; and

a telecentric optical means for collimating principal rays of the exposure light, the telecentric optical means being positioned in an optical path of the exposure light that enters the spatial light modulation means. The spatial light modulation means performs, based on an image signal, spatial light modulation on the exposure light, which has been emitted from the light source, and that has entered the plurality of pixel portions, for each of the plurality of pixel portions.

Further, an exposure method of the present invention is characterized by comprising the steps of:

performing, based on an image signal, spatial light modulation on exposure light, the principal rays of which have been collimated by a telecentric optical system; and

projecting the exposure light on which spatial light modulation has been performed onto a photosensitive material.

Further, the exposure apparatus is characterized by comprising:

a microlens array including a plurality of microlenses that are two-dimensionally arranged at a pitch corresponding to the arrangement of the plurality of pixel portions. The exposure light on which spatial light modulation has been performed by the pixel portions is condensed by each of the microlenses in the microlens array.

Further, the exposure apparatus is characterized in that the exposure light enters the spatial light modulation means at an oblique incident angle with respect to an illumination surface of the spatial light modulation means. Further, the exposure apparatus is characterized in that the spatial light modulation means is a reflection-type spatial light modulation means.

It is possible to achieve the following advantageous effects by collimating each of principal rays of exposure light by arranging a telecentric optical means in an optical path of the exposure light that enters the spatial light modulation means. If the spatial light modulation means is a reflection-type spatial light modulation means, it is necessary to cause the exposure light to enter the illumination surface of the spatial light modulation means at an oblique incident angle with respect to the illumination surface of the spatial light modulation means. In this case, the focus of the exposure light is set to a predetermined position on the illumination surface of the spatial light modulation means. Therefore, in the area of the illumination surface other than the predetermined position, the exposure light is not focused and an image is blurred. If the incident angles of the principal rays of exposure light that illuminates the illumination surface are not uniform, shading caused by the unfocused condition increases. Therefore, if the principal rays of exposure light that illuminates the illumination surface are collimated by the telecentric optical means, it is possible to suppress generation of shading.

Further, in the exposure apparatus including a microlens array for condensing light reflected by the spatial light modulation means, the microlens array is positioned so as to correspond to the pitch of pixels (each of pixel portions of the spatial light modulation means). If the incident angles of the principal rays of the exposure light that illuminates the spatial light modulation means are not uniform, the principal rays of reflected exposure light are not uniform, either. In this case, if the position of the microlens array is shifted (misaligned) in the direction of the optical axis with respect to the imaging position of an image formed by the spatial light modulation means, the imaging position by the imaging optical system positioned on the downstream side of the spatial light modulation means, light reflected by each of pixel portions of the spatial light modulation means does not accurately enter corresponding microlenses. Consequently, the accuracy of the image pattern becomes lower. Further, the angles of principal rays of light output from each of the microlenses forming the microlens array become non-uniform. Therefore, the equal-pitch characteristic of pixels at the focal positions of the microlenses is not maintained, and the quality of an image formed by exposure becomes lower. However, if the principal rays are collimated by the telecentric optical means, even if the microlens array is shifted in the direction of the optical axis, it is possible to cause the light reflected by each of the pixel portions of the spatial light modulation means to accurately enter the microlenses corresponding to the pixel portions. Further, it is possible to maintain the equal pitch characteristic of each image drawing unit (pixel) even after the light has passed through the microlens array.

### BRIEF DESCRIPTION OF THE DRAWINGS

FIG. 1 A schematic diagram illustrating an external view of an exposure apparatus

FIG. 2 A schematic diagram illustrating an external view of a scanner

FIG. 3 A diagram illustrating the internal structure of an exposure head in detail

FIG. 4 A diagram for explaining the structure of a light source

FIG. 5 A diagram for explaining the structure of an LD module

FIG. 6 A schematic perspective view of a DMD

FIG. 7A A diagram illustrating a micromirror inclined at +α degrees

FIG 7B A diagram illustrating a micromirror inclined at −α degrees

FIG. 8A A schematic diagram for explaining the optical path of laser light in a DMD and an imaging optical system when a telecentric optical system is not provided

FIG. 8B A schematic diagram for explaining the optical path of laser light in a DMD and an imaging optical system when a telecentric optical system is provided

FIG. 9A A diagram for explaining unfocused condition in the DMD when a telecentric optical system is not provided

FIG. 9B A diagram for explaining unfocused condition in the DMD when a telecentric optical system is provided

### BEST MODE FOR CARRYING OUT THE INVENTION

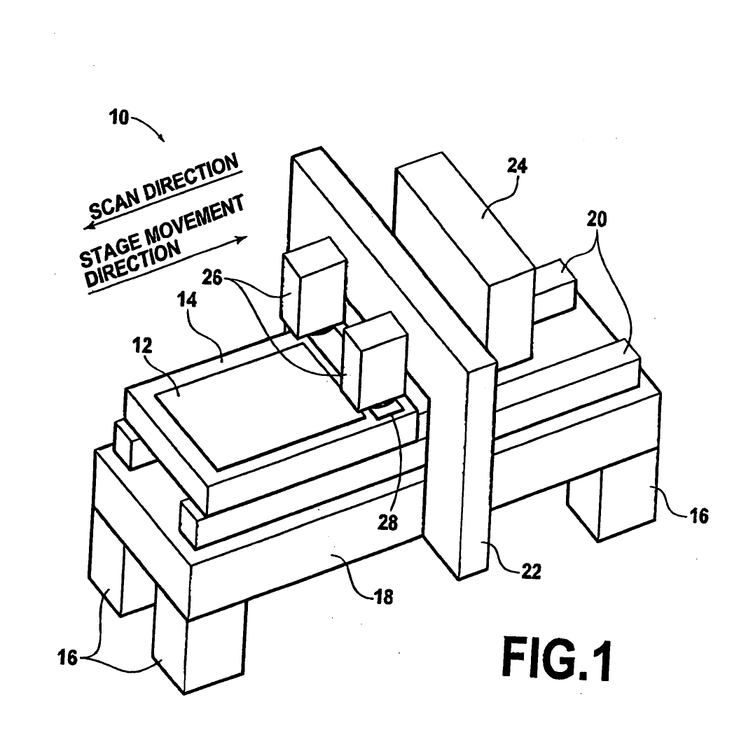

Hereinafter, an exposure apparatus and an exposure method of the present invention will be described with reference to the attached drawings. First, the external view and the structure of the exposure apparatus will be described. FIG. 1 is a schematic diagram illustrating the external view of an exposure apparatus 10. The exposure apparatus 10 includes a moving stage 14. The moving stage 14 is flat-plate-shaped and holds a sheet-shaped photosensitive material 12 on the surface thereof by suction. Further, a thick-plate-shaped base 18 for setting is supported by four leg portions 16 and two guides 20 extending along the stage movement direction are provided on the upper surface of the base 18. The stage 14 is placed in such a manner that the longitudinal direction of the stage 14 is positioned in the stage movement direction. Further, the stage 14 is supported by the guides 20 in such a manner that the stage 14 can move back and forth. Further, the exposure apparatus 10 includes a stage driving device (not illustrated) for driving the stage 14 along the guides 20.

Further, a Japanese-KO-shaped (C-shaped) gate 22 is provided at a central part of the base 18 for setting in such a manner that the Japanese-KO-shaped gate 22 straddles the movement path of the stage 14. Each end of the Japanese-KO-shaped gate 22 is fixed onto either side of the base 18 for setting. Further, a scanner 24 is provided on one side of the gate 22 and a plurality of sensors 26 are provided on the other side of the gate 22. The plurality of sensors 26 detect the leading edge and the rear edge of the photosensitive material 12. Each of the scanner 24 and the sensors 26 is fixed onto the gate 22 and set on the upper side of the movement path of the stage 14. The scanner 24 and the sensors 26 are electrically connected to a controller (not illustrated) and the operation of each of the scanner 24 and the sensors 26 is controlled by the controller.

Further, an exposure surface measurement sensor 28 is provided on the stage 14. When the scanner 24 starts exposure, the exposure surface measurement sensor 28 detects the light amount of laser light with which the exposure surface of the photosensitive material 12 is illuminated by the scanner 24. The exposure surface measurement sensor 28 is provided at an exposure-starting-side end of a surface of the stage 14, the surface on which the photosensitive material 12 is placed. Further, the exposure surface measurement sensor 28 is provided so as to extend in a direction orthogonal to the stage movement direction.

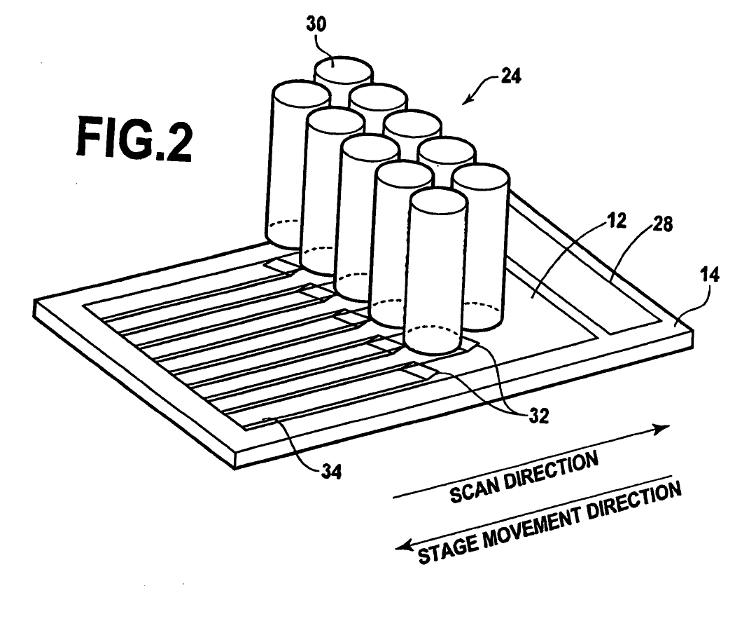

FIG. 2 is a schematic diagram illustrating the external view of the scanner 24. As illustrated in FIG. 2, the scanner 24 includes ten exposure heads 30 that are arranged substantially in matrix form, such as two rows by five columns, for example. Each of the exposure heads 30 is attached to the scanner 24 in such a manner that the pixel column direction of the DMD forms a predetermined set inclination angle with respect to the scan direction. Therefore, an exposure area 32 formed by each of the exposure heads 30 is a rectangular area that is inclined with respect to the scan direction. Further, a band-shaped exposed area 34 is formed on the photosensitive material 12 by each of the exposure heads 30 as the stage 14 moves.

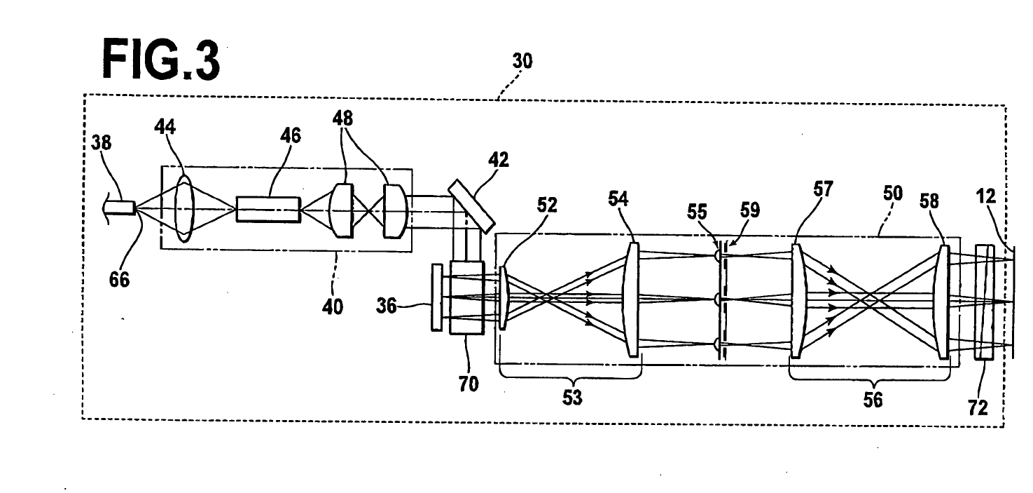

FIG. 3 is a diagram illustrating the internal structure of the exposure head 30 in detail. Laser light (exposure light) emitted from a light source 38 illuminates the photosensitive material 12 through an illumination optical system 40, a mirror 42, a TIR prism 70, a DMD (spatial light modulation means) 36 and an imaging optical system 50. Each of the elements will be sequentially described from the light-source-38 side.

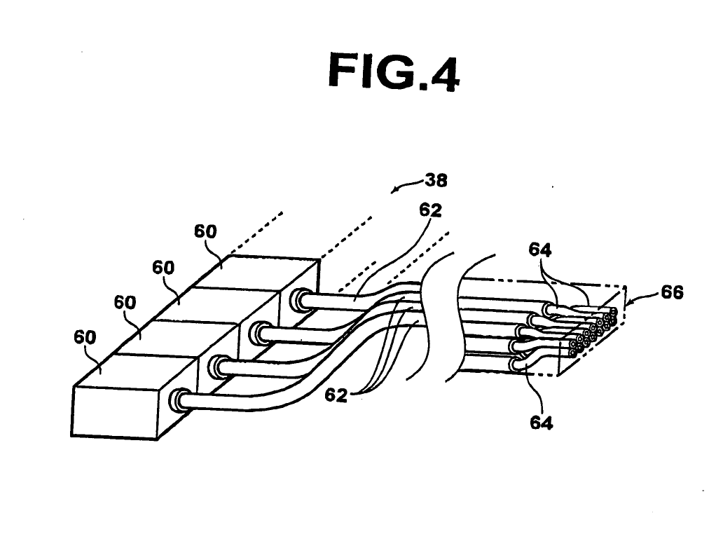

FIG. 4 is a diagram for explaining the structure of the light source 38. The light source 38 includes a plurality of LD modules 60, and each of the LD modules 60 is connected to an end of a first multimode optical fiber 62. Further, the other end of the first multimode optical fiber 62 is connected to an end of a second multimode optical fiber 64. The clad diameter of the second multimode optical fiber 64 is smaller than that of the first multimode optical fiber 62. A plurality of second multimode optical fibers 64 are bundled and a laser emission portion 66 of the light source 38 is formed.

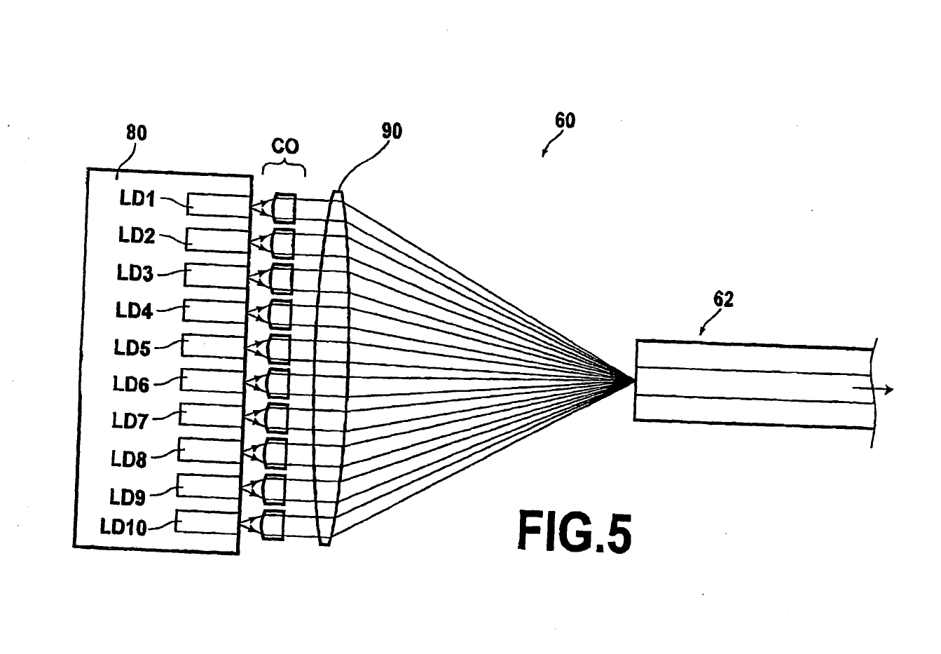

FIG. 5 is a diagram for explaining the structure of the laser module 60. The LD module 60 includes laser diodes LD1 through LD10 (hereinafter, comprehensively represented by “LD”), collimator lenses CO, a condensing lens 90 and the first multimode optical fiber 62. The laser diodes LD1 through LD10 (“LD”) are light emission devices arranged on a heat block 80. Further, the collimator lenses CO are arranged so as to correspond to each of the LD's. Emission light emitted from each of the LD's passes through the collimator lenses CO. Further, the light is condensed by the condensing lens 90. The light condensed by the condensing lens 90 is combined by the first multimode optical fiber 62. The combined light is output from an end of the second multimode optical fiber 64, the other end of which is connected to the first multimode optical fiber 62. The second multimode optical fibers 64 are bundled and the light is further combined.

In the above description, ten collimator lenses CO are provided. A collimator lens array, in which these collimator lenses are integrated, may be used. Further, the LD's are chip-shaped GaN-based semiconductor laser light emission devices of transverse multimode or single-mode. The LD's have the same oscillation wavelength (for example, 405 [nm]) and the same maximum output power of emission (for example, 100 [mW] if the laser is a multimode laser, and 30 [mW] if the laser is a single-mode laser). Further, as the LD's, LD's that have oscillation wavelength other than 405 [nm], as described above, may be used as long as the wavelength is within the range of 350 [nm] to 450 [nm].

Reference will be made to FIG. 3 again. The illumination optical system 40 includes a condensing lens 44, a rod integrator 46 and a telecentric optical system (telecentric optical means) 48. The condensing lens 44 condenses laser light emitted from the light source 38. The rod integrator 46 is positioned in the optical path of laser light that has been condensed by the condensing lens 44. The telecentric optical system 48 is provided on the forward side of the rod integrator 46. In other words, the telecentric optical system 48 is provided on the mirror 42 side of the rod integrator 46.

The rod integrator 46 outputs the laser light that has been condensed by the condensing lens 44 after causing the intensity of the light to be uniform and even. The telecentric optical system 48 is formed by two planoconvex lenses that are combined with each other. The telecentric optical system 48 collimates each of principal rays of the laser light that has been output from the rod integrator 48 and outputs the collimated light.

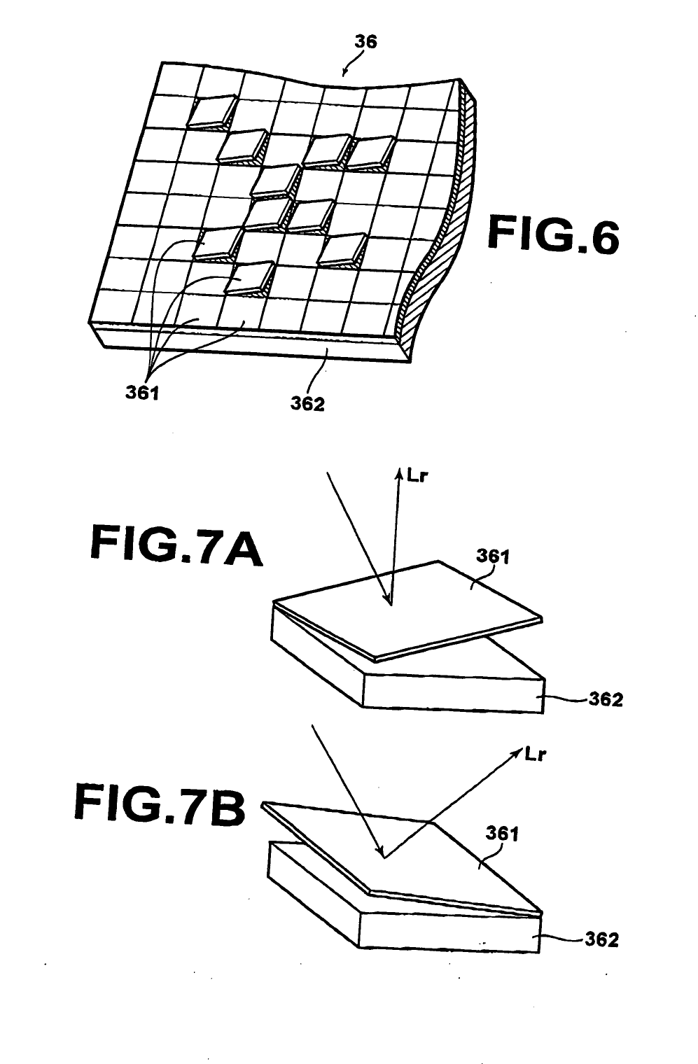

The laser light output from the illumination optical system 40 is reflected by the mirror 42 and enters the DMD 36 at an oblique angle (inclined angle) through a TIR (total internal reflection) prism 70. The DMD 36 is a mirror device, in which a multiplicity micromirrors for forming pixels are arranged in grid form. In the present embodiment, a case in which the DMD is used as the spatial light modulator is described. However, the spatial light modulator is not limited to the DMD as long as the device forms a two-dimensional pattern of light based on an image signal. FIG. 6 is a schematic perspective view of the DMD 36. The DMD 36 is a spatial light modulation means for forming a two-dimensional pattern by performing, based on an image signal, spatial light modulation on light output from the illumination optical system 40. In the DMD 36, a multiplicity of micromirrors 361 (for example, 1024×757 pixels) for forming pixels are two-dimensionally arranged on an SRAM cell (memory cell) 362. Each of the micromirrors 361 is supported by a support post (not illustrated).

Further, the DMD 36 is connected to a controller (not illustrated), which includes a data processing unit and a mirror drive control unit. The data processing unit generates, based on an image signal, a control signal for controlling the inclination angle of each of the micromirrors 361. The mirror drive control unit controls the inclination angle of the reflection surface of each of the micromirrors 361 of the DMD 36 based on the control signal generated by the data processing unit. Specifically, the mirror drive control unit inclines each of the micromirrors 361 based on ON/OFF of the control signal within the range of ±α degrees (for example, ±10 degrees) with respect to the substrate of the SRAM cell 362. FIG. 7A is a diagram illustrating a state in which the micromirror 361 is inclined at +α degrees (ON state). In this case, laser light Lr reflected at the surface of the micromirror 361 is reflected toward a direction in which the laser light Lr enters the imaging optical system 50. FIG. 7B is a diagram illustrating a state in which the micromirror 361 is inclined at −α degrees (OFF state). In this case, laser light Lr reflected at the surface of the micromirror 361 does not enter the imaging optical system 50 but is absorbed by a light absorption plate or the like. Since the inclination angles of the micromirrors 361 are controlled as described above, laser light that has entered the DMD at an oblique angle is reflected to predetermined directions and a two-dimensional pattern is formed.

Reference will be made to FIG. 3 again. The imaging optical system 50 is an imaging means for forming, on the photosensitive material 12, an image of a two-dimensional pattern that has been formed by spatial light modulation by the DMD 36 and for projecting the image onto the photosensitive material 12. The imaging optical system 50 includes a first imaging optical system 53, a microlens array 55, an aperture array 59 and a second imaging optical system 56. The first imaging optical system 53 includes a lens 52 and a lens 54, and the second imaging optical system 56 includes a lens 57 and a lens 58. The two-dimensional pattern formed by the DMD 36 is transmitted through the first imaging optical system 53 and magnified at a predetermined magnification ratio, and an image is formed. Light beam that has passed through the first imaging optical system 53 is condensed separately by each of microlenses in the microlens array 55 that is positioned in the vicinity of the imaging position by the first imaging optical system 53 (a position at which an image is formed by the first imaging optical system 53). The beam that has been separately condensed is transmitted through each of apertures of the aperture array 59 and an image is formed. The two-dimensional pattern formed by light transmitted through the microlens array 55 and the aperture array 59 is further transmitted through the second imaging optical system 56 and magnified at a predetermined magnification ratio. Then, an image of the magnified two-dimensional pattern is formed on the photosensitive material 12. Finally, the two-dimensional pattern formed by the DMD 36 is magnified at a magnification ratio that is the product of the magnification power of the first imaging optical system 53 and that of the second imaging optical system 56, and the magnified image is projected onto the photosensitive material 12. It is not always necessary that the imaging optical system 50 includes the second imaging optical system 56.

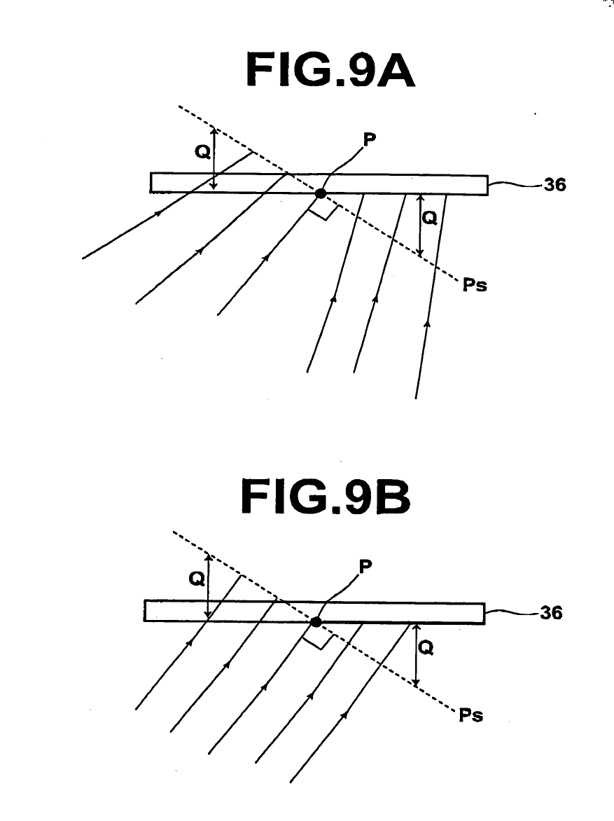

The laser light enters the illumination surface of the DMD 36 at an oblique angle with respect to the illumination surface of the DMD 36. FIG. 9 illustrates a state in which the laser light enters the illumination surface in such a manner. FIG. 9A is a diagram illustrating an optical path of laser light in a case in which a telecentric optical system 48 is not provided on the output side of the rod integrator 46 (an exposure apparatus according the related art). FIG. 9B is a diagram illustrating an optical path of laser light in a case in which a telecentric optical system 48 is provided (an exposure apparatus according to the present embodiment). The light amount shading of an image at an end surface of the rod integrator 48 is substantially even and uniform because the light has been reflected a multiplicity of times. The image at the end surface of the rod integrator 48 is formed on plane Ps including predetermined position P, which is substantially at the center of the illumination surface of the DMD 36. The plane Ps on which the image is formed is not completely the same as the illumination surface of the DMD 36. Consequently, an image at some portion of the illumination surface of the DMD 36 becomes unfocused with respect to the plane Ps (for example, an image at a peripheral portion of the DMD 36 is unfocused by a distance indicated by arrow Q). As illustrated in FIG. 9A, if each of the principal rays of the laser light is not uniform, the brightness of light changes as the degree of unfocused condition (blur) increases. Consequently, shading increases on the surface of the DMD 36.

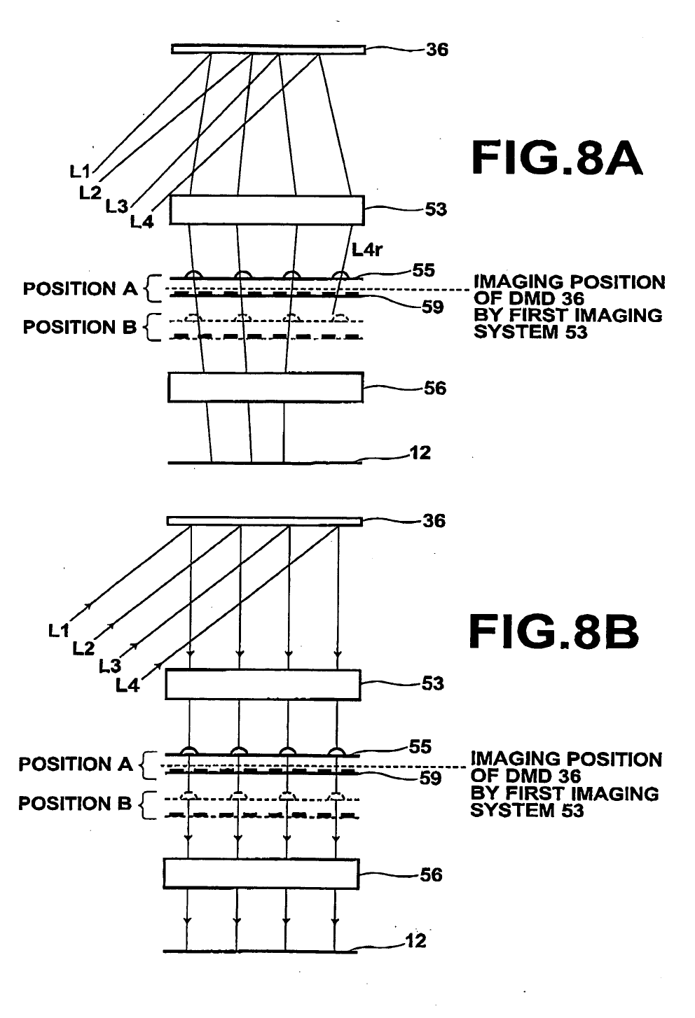

FIG. 8 is a schematic diagram for explaining the optical path of laser light at the DMD 36 and in the imaging optical system 50. FIG. 8A is a diagram illustrating an optical path of laser light in a case in which a telecentric optical system 48 is not provided on the output side of the rod integrator 46 (an exposure apparatus according the related art). FIG. 8B is a diagram illustrating an optical path of laser light in a case in which a telecentric optical system 48 is provided (an exposure apparatus according to the present embodiment). If the position of the microlens array 55 is shifted (misaligned) in the light axis direction with respect to the imaging position of the DMD 36 by the imaging optical system 50, the equal pitch characteristic of the reflection light of each of the micromirrors 361 is lost because the angles of the principal rays are not uniform. Further, the correspondence between each of the micromirrors 361 and respective lenses in the microlens array 55 is lost, and the quality of exposure becomes lower. For example, in FIG. 8A, if the position of the microlens array 55 that should be originally positioned at position A is moved to position B by adjustment, light reflected by a micromirror 361 does not accurately enter a corresponding microlens in some cases, as indicated by line L4r. Further, some light does not pass through the aperture array 59 depending on the incident angle of light entering the microlens array 55, and that may increase shading at the photosensitive material 12.

Further, if the principal rays of light reflected by the DMD 36 are not uniform, the angles of the principal rays passing though the microlenses forming the microlens array 55 become non-uniform. Therefore, the equal pitch characteristic of each image drawing unit at the light condensing position of the microlens is lost. The loss of equal pitch characteristic of each image drawing unit lowers the quality of exposure regardless of presence of the second imaging optical system 56.

Therefore, the telecentric optical system 48 is provided on the light-output side of the rod integrator 46 in the present embodiment. If the telecentric optical system 48 is provided, laser light, the principal rays of which are parallel to each other, enters the DMD 36, as illustrated in FIG. 9B. The angles of the principal rays of the laser light are uniform and the principal rays are parallel to each other. Therefore, it is possible to prevent generation of shading that is caused by the unfocused (out-of-focus) positional relationship between the DMD 36 and the imaging position at the light-output-end surface of the rod integrator 36, the unfocused positional relationship being caused by entrance of light at an oblique angle.

Further, since each of the principal rays of the laser light is collimated, even if the position of the microlens array 55 is adjusted to a position that is shifted in the direction of the light axis from the imaging position of the DMD 36, the imaging position by the first imaging optical system 53, as illustrated in FIG. 8B, the equal pitch characteristic of light reflected by the micromirror 361 is maintained. Further, loss of correspondence between the micromirrors 361 and the microlenses in the microlens array 55 can be prevented. Hence, it is possible to prevent deterioration of the quality of exposure.

Further, since the principal rays of light reflected by the DMD 36 are uniform, the angles of the principal rays of light that passes through the microlenses forming the microlens array 55 are uniform. Therefore, the equal pitch characteristic of each image drawing unit at the light condensing position of the microlens is maintained. Hence, it is possible to prevent deterioration of the quality of exposure.

So far, the present invention has been described using some embodiments. However, the present invention is not limited the aforementioned embodiments. Various embodiments other than the aforementioned embodiments are still within the scope of the present invention.

For example, in the aforementioned embodiments, the telecentric optical system 48 was provided on the light-output side of the rod integrator 46. However, it is not necessary that the telecentric optical system 48 is provided in such a manner as long as the telecentric optical system 48 is provided on the optical path of laser light entering the DMD 36 and the DMD 36 can be illuminated with laser light, the principal rays of which are parallel to each other.

Further, in the aforementioned embodiments, the exposure head 30 including the DMD 36 as the spatial light modulator has been described. However, a transmission-type spatial light modulator (LCD) may be used instead of the reflection-type spatial light modulator. For example, an MEMS-type (Micro Electro Mechanical Systems type) spatial light modulator (SIM: Spatial Light Modulator) may be used. Alternatively, an optical device (PLZT element), which modulates transmission light by an electro optical effect, a liquid crystal shutter array, such as a liquid crystal optical shutter (FLC), and the like may be used instead of the MEMS-type spatial light modulator. The term “MEMS” is a general term referring to a micro system, in which a micro-size sensor, actuator and control circuit by micro machining technique based on an IC production process are integrated. Further, the MEMS-type spatial light modulator refers to a spatial light modulator driven by an electromechanical operation utilizing electrostatic force. Further, a device including a plurality of two-dimensionally-arranged GLV's (Grating Light Value) may be used.

1. An exposure apparatus comprising:
a light source for emitting exposure light;
a spatial light modulation means that includes a plurality of two-dimensionally-arranged pixel portions; and
a telecentric optical means for collimating principal rays of the exposure light, the telecentric optical means being positioned in an optical path of the exposure light that enters the spatial light modulation means, wherein the spatial light modulation means performs, based on an image signal, spatial light modulation on the exposure light, which has been emitted from the light source, and that has entered the plurality of pixel portions, for each of the plurality of pixel portions.

2. An exposure apparatus, as defined in claim 1, further comprising:
a microlens array including a plurality of microlenses that are two-dimensionally arranged at a pitch corresponding to the arrangement of the plurality of pixel portions, wherein the exposure light on which spatial light modulation has been performed by the pixel portions is condensed by each of the microslenses in the microlens array.

3. An exposure apparatus, as defined in claim 1, wherein the exposure light enters the spatial light modulation means at an oblique incident angle with respect to an illumination surface of the spatial light modulation means.

4. An exposure apparatus, as defined in claim 3, wherein the spatial light modulation means comprises a reflection-type spatial light modulation means.

5. An exposure method comprising:
performing, based on an image signal, spatial light modulation on exposure light, the principal rays of which have been collimated by a telecentric optical system; and
projecting the exposure light on which spatial light modulation has been performed onto a photosensitive material.

6. An exposure apparatus, as defined in claim 2 wherein the exposure light enters the spatial light modulation means at an oblique incident angle with respect to an illumination surface of the spatial light modulation means.

7. An exposure apparatus, as defined in claim 6, wherein the spatial light modulation means comprises a reflection-type spatial light modulation means.
